(19) United States
(12) Patent Application Publication
(10) Pub. No.: US 2021/0088486 A1
(43) Pub. Date: Mar. 25, 2021

(54) METHODS AND SYSTEMS FOR DETECTION OF VITAMIN D METABOLITES

(71) Applicant: DH TECHNOLOGIES DEVELOPMENT PTE. LTD., Singapore (SG)

(72) Inventors: Jason Joshua COURNOYER, Framingham, MA (US); Scott B. DANIELS, Framingham, MA (US); Aaron James HUDSON, Framingham, MA (US); Subhasish PURKAYASTHA, Framingham, MA (US)

(21) Appl. No.: 16/976,751

(22) PCT Filed: Jan. 29, 2019
(86) PCT No.: PCT/IB2019/050723

§ 371 Date: Aug. 29, 2020

Related U.S. Application Data
(60) Provisional application No. 62/623,445, filed on Jan. 29, 2018.

(51) Int. Cl. G01N 30/86; G01N 30/14; G01N 30/72; G01N 30/88; G01N 30/60; G01N 1/40

(52) U.S. Cl. CPC G01N 30/8665; G01N 30/14; G01N 30/724; G01N 2030/027; G01N 30/60; G01N 1/4077; G01N 30/88

(57) ABSTRACT

A method and kit for detecting at least two vitamin D metabolites in a biological sample is disclosed, which comprises processing the biological sample to prepare the sample for LC-MS/MS analysis, passing the prepared sample through a liquid chromatography column having an outlet connected to an inlet port of a tandem mass spectrometer to separate said two vitamin D metabolites, if present in the sample, and introduce the two vitamin D metabolites into the tandem mass spectrometer. The method further comprises generating [M+H]⁺ ions of each of the two vitamin D metabolites in said tandem mass spectrometer, and generating two fragment ions of said [M+H]⁺ ions associated with said vitamin D metabolites, wherein said fragment ions are not due to water losses from the [M+H]⁺ ions; and detecting the fragment ions to identify presence of the two metabolites in the biological sample.

### RELATED US APPLICATIONS

This application claims the benefit of priority from U.S. Provisional Application No. 62/623,445, filed on Jan. 29, 2018, the entire contents of which is incorporated by reference herein.

### FIELD

The present teachings relate to the detection of vitamin D metabolites, and more particularly to methods for detecting vitamin D metabolites by mass spectrometry.

### BACKGROUND

Vitamin D is an essential nutrient with important physiological roles in the positive regulation of calcium (Ca2+) homeostasis. Vitamin D can be made de novo in the skin by exposure to sunlight or it can be absorbed from the diet. There are two forms of vitamin D: vitamin D2 (ergocalciferol) and vitamin D3 (cholecalciferol). Both dietary and intrinsically synthesized vitamin D3 must undergo metabolic activation to generate bioactive metabolites. In humans, vitamin D3 is initially hydroxylated primarily in the liver to form 25-hydroxyvitamin D3 (25-hydroxycholecalciferol; calcifediol; 25OHD3) as an intermediate metabolite, which is the major form of vitamin D3 in the circulation. Circulating 25-hydroxyvitamin D3 is then converted by the kidney to 1,25-dihydroxyvitamin D3 (calcitriol; 1,25(OH).2D.3), which is generally believed to be the metabolite of vitamin D3 with the highest biological activity.

Vitamin D₂, which is derived from fungal and plant sources, undergoes a similar pathway of metabolic activation in humans as vitamin D₃, forming the metabolites 25-hydroxyvitamin D₂ (25OHD₂) and 1,25-dihydroxyvitamin D₃ (1,25(OH)₂D₂).

Although measurement of vitamin D, the inactive vitamin D precursor, is rare in clinical settings and has little diagnostic value, measuring the serum levels of 25-hydroxyvitamin D₃ and 25-hydroxyvitamin D₂ (total 25-hydroxyvitamin D; “25OHD”) can be useful in the diagnosis and management of disorders of calcium metabolism. In particular, low levels of 25OHD are indicative of vitamin D deficiency associated with diseases such as hypocalcemia, hypophosphatemia, secondary hyperparathyroidism, elevated alkaline phosphatase, osteomalacia in adults and rickets in children. In patients suspected of vitamin D intoxication, elevated levels of 25OHD distinguishes this disorder from other disorders that cause hypercalcemia.

Although measurement of 1,25(OH)₂D has a limited diagnostic usefulness, nonetheless certain diseases, such as kidney failure, can be diagnosed by reduced levels of circulating 1,25(OH)₂D. Further, elevated levels of 1,25(OH)₂D may be indicative of excess parathyroid hormone or may be indicative of certain diseases such as sarcoidosis or certain types of lymphoma.

Conventionally, radioimmunoassays have been employed to detect vitamin D metabolites using antibodies that are co-specific for 25-hydroxyvitamin D₃ and 25-hydroxyvitamin D₂, and hence cannot resolve 25-hydroxyvitamin D₃ and 25-hydroxyvitamin D₂. Mass spectrometry has also been used for detecting specific vitamin D metabolites. Many of these methods require derivatization of metabolites, though methods for detecting certain underivatized metabolites of vitamin D via mass spectrometry are also known.

There is still a need for improved methods and systems for detecting vitamin D metabolites in a sample, such as a biological sample.

### SUMMARY

In one aspect, the present teachings provide methods for detecting the presence or amount of a vitamin D metabolite in a sample by mass spectrometry, including tandem mass spectrometry. Preferably, the methods of the invention do not include derivatizing the vitamin D metabolites prior to the mass spectrometry analysis. In embodiments discussed below, MRM (multiple reaction monitoring) transitions associated with protonated molecular ions of one or more vitamin D metabolites of interest and their associated fragment ions, e.g., fragment ions that do not involve loss of water, can be used to detect the presence of the vitamin D metabolites in a sample.

In one aspect, a method of detecting 25-hydroxyvitamin D₃ and 25-hydroxyvitamin D₂ in a biological sample is disclosed, which comprises processing the sample so as to prepare the sample for introduction into a tandem mass spectrometer, ionizing the processed sample in an ion source of the tandem mass spectrometer so as to generate precursor protonated ions of 25-hydroxyvitamin D₃, if present in the sample, at a mass-to-charge ratio of 401.3±0.3, and to generate precursor protonated ions of 25-hydroxyvitamin D₂, if present in the sample, at a mass-to-charge ratio of 413.3±0.3, selecting said precursor protonated ions of said 25-hydroxy vitamin D₃ and said 25-hydroxy vitamin D₂ in a first stage of said tandem mass spectrometer. At least a portion of the protonated molecular ions of 25-hydroxyvitamin D₃ and 25-hydroxyvitamin D₂ can be fragmented in a fragmentation module of the mass spectrometer to generate fragment ions. The fragmentation of the protonated molecular ion of 25-hydroxyvitamin D₃ results in generating one or more fragment ions at a mass-to-charge ratio of 257.2±0.3, or a mass-to-charge ratio of 121.1±0.3, or a mass-to-charge ratio of 133.1±0.3, or a mass-to-charge ratio of 147.1±0.3. Further, the fragmentation of the protonated ion of 25-hydroxyvitamin D₂ results in generating fragment ions at a mass-to-charge ratio of 271.2±0.3, or at a mass-to-charge ratio of 133.1±0.3, or at a mass-to-charge ratio of 121.1±0.3, or at a mass-to-charge ratio of 255.2±0.3. At least one of the fragment ions associated with the fragmentation of the protonated molecular ion of 25-hydroxyvitamin D₃ and at least one of the fragment ions associated with the fragmentation of the protonated molecular ion of 25-hydroxyvitamin D₂ are selected using a mass analyzer in a second stage of the tandem mass spectrometer and are detected to identify the presence of 25-hydroxyvitamin D₃ and/or 25-hydroxyvitamin D₂ in the sample.

In some embodiments, the processed sample can be ionized in the ion source of the tandem mass spectrometer so as to generate precursor protonated ions of 25-hydroxyvitamin D₃, if present in the sample, at a mass-to-charge ratio of 401±0.3, or a mass-to-charge ratio of 401.3±0.3, or a mass-to-charge ratio of 401.6±0.3, and to generate precursor protonated ions of 25-hydroxyvitamin D₂, if present in the sample, at a mass-to-charge ratio of 413±0.3, or a mass-to-charge ratio of 413.3±0.3, or a mass-to-charge ratio of 413.6±0.3. Further, the fragmentation of the protonated molecular ion of 25-hydroxyvitamin D₃ results in generating one or more fragment ions at a mass-to-charge ratio of 257.2±0.3, or a mass-to-charge ratio of 257±0.3, or a mass-to-charge ratio of 257.5±0.3, or a mass-to-charge ratio of 256.9±0.3, or a mass-to-charge ratio of 121±0.3, or a mass-to-charge ratio of 121.1±0.3, or a mass-to-charge ratio of 121.4±0.3, or a mass-to-charge ratio of 120.8±0.3, or a mass-to-charge ratio of 133±0.3, or a mass-to-charge ratio of 133.1±0.3, or a mass-to-charge ratio of 133.4±0.3, or a mass-to-charge ratio of 132.8±0.3, or a mass-to-charge ratio of 147±0.3, or a mass-to-charge ratio of 147.1±0.3, or a mass-to-charge ratio of 147.4±0.3, or a mass-to-charge ratio of 146.8±0.3.

In some embodiments, at least a portion of the selected protonated ions of 25-hydroxy vitamin D₂ can be fragmented to generate at least one fragment ion having a mass-to-charge ratio of 120.8, or a mass-to-charge ratio of 121±0.3, or a mass-to-charge ratio of 121.1±0.3, or a mass-to-charge ratio of 121.4±0.3, or a mass-to-charge ratio of 132.8±0.3, or a mass-to-charge ratio of 133±0.3, or a mass-to-charge ratio of 133.1±0.3, or a mass-to-charge ratio of 133.4±0.3, or a mass-to-charge ratio of 270.9±0.3, or a mass-to-charge ratio of 271±0.3, or a mass-to-charge ratio of 271.2±0.3, or a mass-to-charge ratio of 271.5±0.3, or a mass-to-charge ratio of 254.9±0.3, or a mass-to-charge ratio of 255±0.3, or a mass-to-charge ratio of 255.2±0.3, or a mass-to-charge ratio of 255.5±0.3. In some embodiments, the method can further include quantifying concentration of the 25-hydroxy vitamin D₃ and the 25-hydroxyvitamin D₂ in a sample. By way of example, in some such embodiments, standards, such as deuterated 25-hydroxy vitamin D₃ and/or deuterated 25-hydroxy vitamin D₂, can be used to quantify the amount of these vitamin D metabolites in a sample. By way of example, D6-25-hydroxyvitamin D₃ can be used as a standard. In some such embodiments, the D6-25-hydroxyvitamin D₃ is ionized to generate a protonated molecular ion at a mass-to-charge ratio of 407.3±0.3, and this protonated molecular ion is fragmented to generate fragment ions at a mass-to-charge ratio of 263.2±0.3, or 121.1±0.3, or 173.1±0.3, or 147.1±0.3. Further, in some embodiments, the D6-25-hydroxyvitamin D₃ can be ionized to generate a protonated molecular ion at a mass-to-charge ratio of 407±0.3, or a mass-to-charge ratio of 407.3±0.3, or a mass-to-charge ratio of 407.6±0.3, and this protonated molecular ion is fragmented to generate fragment ions at a mass-to-charge ratio of 262.9±0.3, or a mass-to-charge ratio of 263±0.3, or a mass-to-charge ratio of 263.2±0.3, or a mass-to-charge ratio of 263.5±0.3, or a mass-to-charge ratio of 120.8±0.3, or a mass-to-charge ratio of 121±0.3, or a mass-to-charge ratio of 121.1±0.3, or a mass-to-charge ratio of 121.4±0.3, or a mass-to-charge ratio of 172.8±0.3, or a mass-to-charge ratio of 173±0.3, or a mass-to-charge ratio of 173.1±0.3, or a mass-to-charge ratio of 173.4±0.3, or a mass-to-charge ratio of 146.8±0.3, or a mass-to-charge ratio of 147±0.3, or a mass-to-charge ratio of 147.1±0.3, or a mass-to-charge ratio of 147.4±0.3. The D6-25-hydroxyvitamin D₃ can be detected via the detection of at least one of these fragment ions in an ion detector of the mass spectrometer. In some embodiments, the amount of 25-hydroxyvitamin D₃ and/or 25-hydroxyvitamin D₂ can be quantified based on a comparison of the ratios of the signal intensities associated with the detected fragment ions corresponding to 25-hydroxyvitamin D₃ or 25-hydroxyvitamin D₂ and the signal intensity of the detected fragment ion corresponding to the standard, e.g., D6-25-hydroxyvitamin D₃.

In some embodiments, the 401.3±0.3/257±0.3 MRM transition of 25-hydroxyvitamin D₃ and the 413.3±0.3/271.2±0.3 MRM transition of 25-hydroxyvitamin D₂ are employed for the detection of presence of these vitamin D metabolites in a sample. In some such embodiments in which D6-25-hydroxyvitamin D₃ is employed as a standard, the 407.3±0.3/263.2±0.3 and/or 407.3±0.3/121.1±0.3 MRM transition of this standard is employed for quantifying the amount of 25-hydroxyvitamin D₃ and/or 25-hydroxyvitamin D₂ in the sample.

In some embodiments, the 25-hydroxyvitamin D₃ and 25-hydroxyvitamin D₂ are detected in a sample without derivatizing these vitamin D metabolites, though in other embodiments the derivatization of these vitamin D metabolites can be employed. Further, in some embodiments, the 25-hydroxyvitamin D3 and 25-hydroxyvitamin D₂ are detected in a sample under study in a single assay.

In some embodiments, the processing of the sample prior to its introduction into the mass spectrometer can include using at least one liquid chromatography (LC) column for selectively separating the 25-hydroxyvitamin D₃ and the 25-hydroxyvitamin D₂ from one or more other constituents of the sample. In some embodiments, the step of using at least one LC column can include using a trap column to bind the 25-hydroxyvitamin D₃ and the 25-hydroxyvitamin D₂ and subsequently using an analytical column to elute the bound 25-hydroxy vitamin D₃ and the bound 25-hydroxyvitamin D₂ for introduction into said tandem mass spectrometer. In some embodiments, the LC column can be employed to resolve at least one of 25-hydroxyvitamin D₃ and 25-hydroxyvitamin D₂ from an isobaric interference.

A variety of ion sources can be employed to generate the molecular ions of the vitamin D metabolites. Some examples of suitable ion sources include, without limitation, an electrospray ionization source, atmospheric pressure chemical ionization (APCI) source, a photoionization source, and electron ionization source, a fast atom bombardment (FAB)/liquid secondary ionization (LSIMS) source, a matrix assisted laser desorption ionization (MALDI) source, a field ionization source, a field desorption source, a thermospray/plasmaspray ionization source, and a particle beam ionization source.

In some embodiments, processing the sample can include using any of a precipitating agent and centrifugation. By way of example, a precipitating agent can be used to precipitate one or more proteins in the sample and the sample can be centrifuged to separate the liquid supernatant, which can then be introduced into a LC column of an LC-MS/MS instrument.

In some embodiments, the 25-hydroxyvitamin D₂ and 25-hydroxyvitamin D₃ are detected in a single run of said tandem mass spectrometer.

The above methods can be used for detecting vitamin D metabolites in a variety of biological samples. Some examples of suitable samples include, without limitation, blood, plasma, serum, bile, saliva, urine, tears, etc.

In a related aspect, a method for detecting at least two vitamin D metabolites in a biological sample is disclosed, which comprises processing the biological sample to prepare the sample for LC-MS/MS analysis, passing the prepared sample through a liquid chromatography column having an outlet port connected to an inlet port of a tandem mass spectrometer to separate said two vitamin D metabolites, if present in the sample, and introduce the two vitamin D metabolites into the tandem mass spectrometer. The method further comprises generating [M+H]⁺ ions of each of the two vitamin D metabolites in said tandem mass spectrometer, and generating two fragment ions of said [M+H]⁺ ions associated with said vitamin D metabolites, wherein said fragment ions are not due to water losses from the [M+H]⁺ ions; and detecting the fragment ions to identify presence of the two metabolites in the biological sample.

In some embodiments, the step of processing the sample can include using at least one LC column that can selectively separate the two vitamin D metabolites from one or more other components in the sample.

In some embodiments, the LC column can include a trap column to bind the two vitamin D metabolites and an analytical column for eluting the bound vitamin D metabolites for introduction into the tandem mass spectrometer. In some embodiments, the step of using the LC column resolves at least one of said two vitamin D metabolites from an isobaric interference, such as an isobaric interference due to 3-epi-25-hydroxyvitamin D₃. In some embodiments, the analytical column is a pentafluorophenyl column.

By way of example, the vitamin D metabolites can be any of 25-hydroxyvitamin D₃, 25-hydroxyvitamin D₂, 1,25-dihydroxyvitamin D₃ and 1,25-dihydroxyvitamin D₂.

Further, in some embodiments, the [M+H]⁺ ions are generated using electrospray ionization, though in some embodiments, the ions are generated by atmospheric pressure chemical ionization.

The above method can further include quantifying concentration of the two vitamin D metabolites in said sample based on comparison of signal intensities corresponding to fragment ions associated with said two metabolites with a respective signal intensity obtained from at least one standard, such as deuterated versions of the vitamin D metabolites. In some embodiments, the step of processing the sample includes adding at least one standard to the sample. Further, in some embodiments, the processing step can include using one or more precipitating reagents and centrifugation, e.g., to remove sample constituents which might interfere with the detection of the vitamin D metabolites of interest.

The above method can be used for detecting vitamin D metabolites in a variety of biological samples. Some example of suitable samples include, without limitation, blood, plasma, serum, bile, saliva, urine, tears, etc.

In a related aspect, a method for detecting a vitamin D metabolite in a biological sample using an LC-MS/MS instrument is disclosed, which includes processing the biological sample such that the processed sample is suitable for introduction into an LC-MS/MS instrument, passing the processed sample through a liquid chromatography module of the LC-MS/MS instrument to separate the vitamin D metabolite, and generating a protonated intact molecular ion of the separated vitamin D metabolite in a tandem mass spectrometer module of said LC-MS/MS instrument. By way of example, in some embodiments, the protonated intact molecular ion is generated by electrospray ionization. The protonated intact molecular ion is fragmented to generate at least one fragment ion that does not represent water loss from the protonated intact molecular ion. The fragment ion is detected to identify presence of the vitamin D metabolite in the biological sample. In some implementations of such a method, the liquid chromatography module includes a trap column to bind the vitamin D metabolite and an analytical column for subsequently eluting the bound vitamin D metabolite, thereby separating the vitamin D metabolite. By way of example, the analytical column is a pentafluorophenyl column.

In some embodiments, the step of passing the biological sample through the liquid chromatography module resolves the vitamin D metabolite from an isobaric interference, such as 3-epi-25-hydroxyvitamin D₃.

In some embodiments, at least one standard, e.g., an internal standard, is used to quantify the amount of the vitamin D metabolite, if any, in the sample. By way of example, a standard can be added to the sample prior to its processing and subsequent introduction to the mass spectrometer. Further, in some embodiments, precipitation reagents and centrifugation can be used to separate one or more vitamin D metabolites of interest from one or more interfering constituents of the sample.

Similar to the previous embodiments, the above method can be employed to identify and quantify whether a vitamin D metabolite of interest is present in a variety of biological samples. By way of example, the biological sample can be, without limitation, blood, plasma, serum, bile, saliva, urine, tears, etc.

In some embodiments, a kit is disclosed for detecting and measuring the concentration of at least two vitamin D metabolites in a biological sample. The kit comprising two or more calibrators, each containing two or more standards with known concentrations in the calibrators selected from the group consisting of 25-hydroxyvitamin D₃, 25-hydroxyvitamin D₂, 1,25-dihydroxyvitamin D₃ and 1,25-dihydroxyvitamin D₂; an isotopic version of at least one of the two or more standards, each of the isotopic versions having a known concentration; a system suitability mixture comprising a known concentration of 25-OH-Vitamin D₃, a known concentration of 25-OH-Vitamin D₂ and a known concentration of 3-epi-25-OH-Vitamin D₃; a pentafluorophenyl liquid chromatographic column; one or more solvents; and instructions for carrying out the method according to any of the embodiments described herein.

In some embodiments, a method of detecting or measuring the concentration of 25-hydroxyvitamin D₃ and 25-hydroxyvitamin D₂ in a biological sample is described, the method can comprise: processing the sample to prepare the sample for introduction into a tandem mass spectrometer, said processing the sample comprising injecting the sample into a single pentafluorophenyl column, and eluting a processed sample therefrom using a gradient to effect a separation; ionizing said processed sample in an ion source of the tandem mass spectrometer so as to generate precursor protonated ions of said 25-hydroxyvitamin D₃, if present in said sample, at a mass-to-charge ratio of 401.3±0.3, and to generate precursor protonated ions of said 25-hydroxyvitamin D₂, if present in said sample, at a mass-to-charge ratio of 413.3±0.3; selecting said precursor protonated ions of said 25-hydroxy vitamin D₃ and said 25-hydroxy vitamin D₂ in a first analyzer of said tandem mass spectrometer; fragmenting at least a portion of said selected protonated ions of 25-hydroxy vitamin D₃ to generate at least one fragment ion having any of 257.2±0.3, 121.1±0.3; 133.1±0.3, and 147.1±0.3 mass-to-charge ratio, and fragmenting at least a portion of said selected protonated ions of 25-hydroxy vitamin D₂ to generate at least one fragment ion having any of 271.2±0.3, 133.1±0.3, 121.1±0.3, and 255.2±0.3 mass-to-charge ratio; and using a second analyzer of said tandem mass spectrometer that is set to detect said at least one of said fragment ions of the 25-hydroxy vitamin D₃ and said at least one of said fragment ions of 25-hydroxy vitamin D₂ to identify any of said 25-hydroxy vitamin D₃ and 25-hydroxy vitamin D₂ in said sample; measuring a signal of the detected at least one of said fragment ions of the 25-hydroxy vitamin D₃ and said at least one of said fragment ions of 25-hydroxy vitamin D₂; and using said signal to determine a quantity of any of said 25-hydroxy vitamin D₃ and 25-hydroxy vitamin D₂ in said sample.

In some embodiments, the ion source may be an ACPI source. In some embodiments, the ion source may be an ESI source.

In some embodiments, the ion source is an electrospray ion source or an atmospheric pressure chemical ionization (APCI) source.

Further understanding of various aspects of the present teachings can be obtained by reference to the following detailed description in conjunction with the associated drawings, which are described briefly below.

### BRIEF DESCRIPTION OF THE DRAWINGS

FIG. 1 is a flow chart depicting various steps in an embodiment of a method according to the present teachings for identifying vitamin D metabolites in a sample,

FIG. 2 schematically depicts a tandem mass spectrometer suitable for implementing methods according to the present teachings,

FIG. 3 is a linearity plot of mean calculated concentration v.s. actual concentration for the 25(OH)D₃ QUANT transition,

FIG. 4 is a linearity plot of mean calculated concentration v.s. actual concentration for the 25(OH)D₃ QUAL transition,

FIG. 5 is a linearity plot of mean calculated concentration v.s. actual concentration for the 25(OH)D₂ QUANT transition, and

FIG. 6 is a linearity plot of mean calculated concentration v.s. actual concentration for the 25(OH)D₂ QUAL transition.

### DETAILED DESCRIPTION

The present teachings are generally related to methods and systems for detecting vitamin D metabolites. In some embodiments, tandem mass spectrometry is used to detect vitamin D metabolites, such as 25-hydroxyvitamin D and/or 1,25-dihydroxy vitamin D.

In many embodiments discussed below, liquid chromatography (LC)-tandem mass spectrometry (e.g., MS/MS) is employed to detect one or more vitamin D metabolites in a sample of interest via the detection of specific MRM transitions of the metabolites. By way of example and as discussed in more detail below, a precursor ion of a vitamin D metabolite of interest (herein also referred to as a parent ion) generated in an ion source of the mass spectrometer can be selected via a mass analyzer in a first stage of the spectrometer, and the selected precursor ion can be fragmented in a fragmentation module of the spectrometer (e.g., a collision cell). A fragment ion (a daughter ion) having a particular m/z ratio can be selected by another mass analyzer in a second stage of the mass spectrometer and detected by a detector positioned downstream of the second mass analyzer. The detection of parent/daughter pair allows the identification of the presence of the vitamin D metabolite of interest in the sample.

Various terms are used herein consistent with their common meanings in the art. For additional clarity, certain terms are defined below.

### Vitamin D Metabolite

The term ‘vitamin D metabolite’ refers to any chemical species that may be found in the circulation of a biological organism that is formed by a biosynthetic or metabolic pathway for vitamin D or a synthetic vitamin D analogue. Vitamin D metabolites include forms of vitamin D that are generated by a biological organism, such as an animal, or that are generated by biotransformation of a naturally occurring form of vitamin D or a synthetic vitamin D analog. In certain preferred embodiments, a vitamin D metabolite is formed by the biotransformation of vitamin D₂ or vitamin D₃. In particularly preferred embodiments, the vitamin D metabolite is one or more compounds selected from the group consisting of 25-hydroxyvitamin D₃, 25-hydroxyvitamin D₂, 1,25-dihydroxyvitamin D₃ and 1,25-dihydroxyvitamin D₂.

25-hydroxyvitamin D₃ and 25-hydroxyvitamin D₂.

25-hydroxyvitamin D₃ and 25-hydroxyvitamin D₂ are particular vitamin D metabolites that represent the main body reservoir and transport form of vitamin D in a biological organism. By way of example, 25-hydroxyvitamin D₃ and 25-hydroxyvitamin D₂ metabolites are measured to identify a possible vitamin D deficiency.

### Biological Sample

The term ‘biological sample’ refers to a sample obtained from any biological source, such as an animal, a cell culture, an organ culture, etc. Examples of biological samples obtained from a human are blood, plasma, serum, hair, muscle, urine, saliva, tear, cerebrospinal fluid, or other tissue sample. Such samples may be obtained, for example, from a patient seeking diagnosis, prognosis, or treatment of a disease or condition.

### Derivatizing

As used herein, “derivatizing” means reacting two molecules to form a new molecule. Derivatizing agents may include isothiocyanate groups, dinitro-fluorophenyl groups, nitrophenoxycarbonyl groups, and/or phthalaldehyde groups.

### Prepared Sample, Processing, Preparation, Removing Interferences

The terms ‘prepared sample’ or a “processed sample” refers to a sample, such as a biological sample, that can be analyzed by an LC-MS/MS instrument without obstructing the normal operation of the instrument. The prepared sample can originate from a biological sample that has undergone a procedure that removes components that would otherwise interfere with the analysis. Examples of methods for processing a sample include, without limitation, filtration, extraction, precipitation, centrifugation, dilution, combinations thereof and the like.

### Purification

As used herein, the term “purification” refers to a procedure that enriches the amount of one or more analytes of interest relative to one or more other components of a sample. Purification, as used herein does not necessarily require the isolation of an analyte from all others. In preferred embodiments, a purification step or procedure can be used to remove one or more interfering substances, e.g., one or more substances that would interfere with the operation of the instruments used in the methods or substances that may interfere with the detection of an analyte ion by mass spectrometry.

### Mass Spectrometry

The term ‘mass spectrometry’ or MS refer to an analytical technique for identifying compounds based on their mass. MS employs an instrument known as a mass spectrometer, which comprises an ion source and a mass analyzer that together are used to measure the amount of one or more target compounds based on their mass-to-charge, or m/z, ratios. A sample containing the target compound is introduced into the MS first via the ion source wherein the target compound is ionized. The mass analyzer subsequently measures a discriminate signal that corresponds to the m/z value of the ionized target compound with an intensity that can be proportional to the amount of the target analyte in the sample.

### Tandem Mass Spectrometer

The term ‘tandem mass spectrometer’, such as MS/MS, refers to type of mass spectrometer that comprises two or more consecutive stages that allow transmission of ions based on their m/z ratios and that are separated by a chamber that affords fragmentation of the ions. In multiple reaction monitoring mode, or MRM, using an MS/MS instrument, the second stage of the instrument only allows transfer of a fragment ion to the detector that was generated during fragmentation of a precursor ion that was selected by the first stage.

### Liquid Chromatography

The term ‘liquid chromatography’, or LC, refers to a process of separating compounds by selectively retaining them, to different degrees, to a functionalized medium as a bulk solution carrying the compounds moves uniformly through the medium. The medium, or stationary phase, consists of minute porous particles with functionalized surfaces and the type of functionality is chosen based on how it interacts with compounds to be separated. The type of bulk solution, or mobile phase, used is selected to facilitate the binding and subsequent release of the compounds from the surface of the medium. The compounds are separated based on their retention time, which is the characteristic time it takes the compounds to travel through the column to the detector.

### High Performance Liquid Chromatography (HPLC)

The term ‘high performance liquid chromatography’, or HPLC, refers to liquid chromatography in which the degree of separation is increased by forcing the mobile phase under high pressure (e.g., 5000 psi) through the stationary phase that is densely packed into a column.

### LC-MS/MS Instrument

The term ‘liquid chromatography-mass spectrometry/mass spectrometry’, or LC-MS/MS, refers to an analytical technique wherein HPLC and MS modules are combined into a single instrument that provides a high level of specificity for an analysis. The high level of specificity is achieved because a compound is identified and measured based on its characteristic retention time and precursor and fragment ion m/z values.

### Separating

The term ‘separating’ refers to the use of liquid chromatography to achieve different retention times for one or more target compounds.

### Protonated Intact Molecular Ion

The term ‘protonated intact molecular ion’ refers to a non-fragmented molecule that is positively ionized by the addition of at least one proton.

### Fragmenting

The term ‘fragmenting’ refers to any mass loss experienced by the molecule that occurs during ionization in the source or in the mass analyzer of a MS/MS system.

### Fragment Ion

The term ‘fragment ion’ refers to an ionized fraction of the precursor ion that is detected in an MS/NIS system.

### Ionization

The term “ionization” as used herein refers to the process of generating an analyte ion having a net electrical charge equal to one or more electron units. Negative ions are those having a net negative charge of one or more electron units, while positive ions are those having a net positive charge of one or more electron units.

### Water Loss

The term ‘water loss’ refers to the loss of a water molecule experienced by an ionized molecule represented by a m/z ratio decrease of approximately 18 Daltons.

### Measuring the Amounts

The term ‘measuring the amounts’ refers to converting the results from an assay performed on a test sample to the actual amount of a target analyte in the test sample by use of a calibration curve. The calibration curve is generated by assaying a set of standard samples that contain known amounts of the target analyte in a matrix similar to that of the test sample.

### Mass-to-Charge Ratio

The term ‘mass-to-charge ratio’ refers to the ratio of mass to electric charge of an ionized molecule of interest.

### Precursor Ion

The term ‘precursor ion’ refers to an ionized molecule that is isolated in the first stage of a tandem mass spectrometer that is subsequently fragmented.

### [M+H]⁺ Ion

The term [M+H]⁺ ion refers to the singly protonated non-fragmented form of a molecule analyzed using a mass spectrometer.

### About

The term “about” as used herein in reference to quantitative measurements, refers to the indicated value plus or minus 10%.

### Additional Information on “Vitamin D Metabolite”

Vitamin D metabolites are derived from dietary ergocalciferol (from plants, vitamin D₂) or cholecalciferol (from animals, vitamin D₃), or by conversion of 7-dihydrocholesterol to vitamin D₃ in the skin upon UV-exposure. Vitamin D₂ and D3 are subsequently hydroxylated in the liver to form 25-hydroxyvitamin D₂ and 25-hydroxyvitamin D₃. 25-hydroxyvitamin D₂ and 25-hydroxyvitamin D₃ represent the main body reservoir and transport form of vitamin D; they are stored in adipose tissue or are tightly bound by a transport protein while in circulation. 25-hydroxyvitamin D₂ and 25-hydroxyvitamin D₃ can be further hydroxylated in the kidney to form 1,25-dihydroxyvitamin D₂ and 1,25-dihydroxyvitamin D₃, which are the hormonally active metabolites. Therefore, a vitamin D metabolite can be one or more compounds, such as 25-hydroxyvitamin D₂, 25-hydroxyvitamin D₃, 1,25-dihydroxyvitamin D₂ and 1,25-dihydroxyvitamin D₃.

### Additional Information on Processing a Sample

In some embodiments, a sample is initially processed so as to enrich the amount of one or more analytes of interest relative to one or more other components of the sample. Such enrichment does not necessarily require isolation of the analytes from all other components. Some examples of sample preparation include, without limitation, filtration, extraction, precipitation, centrifugation, dilution, combinations thereof and the like. In some embodiments, protein precipitation and liquid-liquid extraction are preferred methods of preparing a liquid biological sample, such as serum or plasma, for analysis by liquid chromatography and/or mass spectrometry. Protein precipitation may be used to remove most of the protein from the sample leaving analytes of interest soluble in the supernatant. The samples can then be centrifuged to separate the liquid supernatant containing the analytes from the precipitated proteins. The resultant supernatant can be analyzed with liquid chromatography with subsequent mass spectrometry analysis. Liquid-liquid extraction may be used to selectively extract one or more analytes from a biological sample using an immiscible solvent system containing one or more organic solvents. The organic layer containing the analytes is decanted away from the aqueous layer, which contains the unwanted sample components and that is discarded. The organic layer can be dried and reconstituted with a solvent that solubilizes the analytes and that is compatible with the analytical analysis.

Additional Information on “a Sample Composition that is Compatible with an LC-MS/MS Instrument”

In some embodiments in which LC-MS/MS is employed for detecting a vitamin D analyte of interest in a sample, the sample can be prepared to be compatible with LC-MS/MS instrumentation. By way of example, the sample preparation procedure can include removing one or more substances that would interfere with analysis and LC-MS/MS instrument operation. Some examples of such sample preparation can include, without limitation, filtration, extraction, precipitation, centrifugation, dilution, combinations thereof and the like. Protein precipitation and liquid-liquid extraction, which can be employed for preparation of samples for LC-MS/MS analysis, remove sample components, like proteins, that could otherwise block the liquid stream running from an LC module, e.g., an HPLC module, to the MS module. Blocking the liquid stream could cause both errors in data acquisition and instrument failure.

In embodiments discussed below, mass spectrometry is employed to detect metabolites of vitamin D, such as 25-hydroxyvitamin D₃ and 25-hydroxyvitamin D₂. As noted above, mass spectrometry (MS) refers to an analytical technique for identifying a compound based upon its molecular weight. A typical MS system can include an ion source and a mass analyzer. Detecting compounds using MS can include, e.g., (1) ionizing one or more compounds in the ion source of the MS to form electrically charged ions of the compounds; and (2) using the mass analyzer to separate and detect the ions based on their mass-to-charge (m/z) ratios.

Some examples of ionization techniques that can be utilized by the ion source of the MS include, without limitation, electrospray ionization (ESI), atmospheric pressure chemical ionization (APCI), photoionization, electron ionization, fast atom bombardment (FAB)/liquid secondary ionization (LSIMS), matrix assisted laser desorption ionization (MALDI), field ionization, field desorption, thermospray/plasmaspray ionization, and particle beam ionization. The skilled artisan will understand that the choice of ionization method can be determined based on the analyte to be measured, type of sample, the type of detector, the choice of positive versus negative mode, etc.

Some suitable mass analyzers for determining m/z ratios include, without limitation, quadrupole analyzers, ion traps analyzers, and time-of-flight analyzers. The ions may be detected using several detection modes, particularly scanning and selection modes. For scanning mode, depending on the type of analyzer, a value of at least one m/z-dependent parameter is ramped across a range of values allowing certain charged compounds to strike the detector based on their mass-to-charge ratios. This ramping generates a mass spectrum with an x-axis being a range of low to high mass-to-charge ratios and y-axis being the intensity of the signal corresponding to m/z ratios. For example, in a quadrupole or quadrupole ion trap instrument, ions in an oscillating radio frequency field experience a force proportional to the DC potential applied between electrodes, the amplitude of the RF signal, and the m/z value. The voltage and amplitude settings can be ramped across a defined range so that only ions having a particular m/z travel the length of the quadrupole and strike the detector while all other ions are deflected. An instrument calibration is used to transform voltage and amplitude settings to m/z values to generate the mass spectrum. Selection mode is different from scanning mode such that discrete m/z-dependent settings are used to selectively measure the signal for specific m/z values. For example, selective ion monitoring mode (SIM) can be used to only monitor a signal corresponding to a specific m/z value.′

In some cases, tandem mass spectrometry, e.g., MS/MS, can be used to enhance the resolution of a single MS stage. An MS/MS instrument can have two consecutive stages of m/z separation. A fragmentation chamber, e.g., a collision cell, can be placed between the two stages for fragmenting selected ionized compounds generated in the first stage. For example, a compound can be ionized to generate a precursor ion (also called a parent ion) that is selected in the first stage and subsequently fragmented in the fragmentation chamber to yield one or more fragment ions (also called daughter ions or product ions) that are then analyzed in the second stage. By careful selection of precursor ions, only ions produced by certain analytes are passed to the fragmentation chamber, where collision with atoms of an inert gas produce the daughter ions. Because both the precursor and fragment ions are produced in a reproducible fashion under a given set of ionization/fragmentation conditions, the MS/NIS technique can provide an extremely powerful analytical tool. For example, the combination of selection/fragmentation can be used to eliminate interfering substances, and can be particularly useful in analyzing complex samples, such as biological samples. A common MS/MS instrument is a triple quadrupole, which contains 3 sets of consecutively aligned quadrupoles. The first and last quadrupoles (Q1 and Q3, respectively) have the ability to scan or select ionized compounds. The middle quadrupole is the collision cell that is pressurized with a collision gas and set to transmit ionized compounds over a wide range of m/z values.

In some embodiments, MS/MS is employed in conjunction with liquid chromatography (LC), which is a chemical analysis process of selectively retaining one or more compounds solvated in a carrier bulk solution as the solution permeates, e.g., uniformly, through a column packed with a medium. Each target compound experiences a different degree of retention while traveling through the column depending on the type of medium and solution composition chosen. The differences in retention affords separation of structurally different compounds with respect to time. The retention time of a compound is the characteristic time it takes for that compound to travel through to the outlet port of the column.

The bulk carrier solution, also known as mobile phase, can be a solution with a composition that does not change over the course of an LC experiment. This type of separation is termed isocratic separation. The use of a mixture of different mobile phases whose proportions change over the course of an LC experiment is termed gradient separation.

The medium can typically include minute porous particles. The particles have a bonded surface that interacts with the various chemical moieties of the target compounds. The type of medium is chosen based on the strength of the interaction of the target compounds with the bonded surface. For example, one suitable bonded surface is a hydrophobic bonded surface such as an alkyl bonded surface. Alkyl bonded surfaces include C-4, C-8, or C-18 bonded alkyl groups, preferably C-18 bonded groups. Hydrophobic interactions occur between the alkyl bonded surfaces and the nonpolar regions of the target molecules as they travel though the medium. The degree of attraction or repulsion affects the time it takes the target molecule to travel from the inlet port to the outlet port of the column, which is the retention time.

A type of LC known as high performance liquid chromatography, or HPLC, is a type of LC process in which the degree of separation of compounds within a sample under analysis is increased by forcing the mobile phase under pressure through a stationary phase, typically a densely packed column. HPLC uses pressure ranges upwards of 5000 psi as opposed to traditional liquid chromatography, which typically uses gravity to effect separation. HPLC instruments often have the option to heat columns in order to lower backpressure and affect chromatography aspects like peak shape.

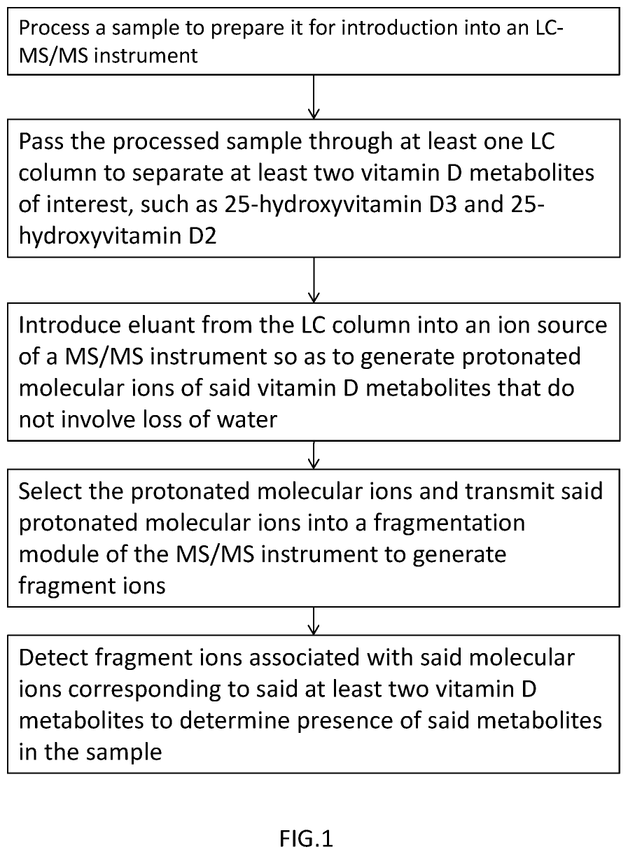

In some embodiments, methods according to the present teachings can be employed to detect the presence of 25-hydroxyvitamin D₃ and 25-hydroxyvitamin D₂ in a sample, e.g., a biological sample using an LC-MS/MS instrument. With reference to the flow chart of FIG. 1, in some implementations of such an embodiment, a biological sample of interest can be initially processed to prepare a processed sample that can be introduced into the LC-MS/MS instrument.

Such processing of the sample can be used, for example, to remove one or more interfering components. Various procedures may be used for this purpose depending on the type of sample or the type of LC. Some examples of such processing include, without limitation, filtration, extraction, precipitation, centrifugation, dilution, combinations thereof and the like. Protein precipitation is one method of preparing a liquid biological sample, such as serum or plasma, for chromatography. Such protein purification methods are well known in the art, for example, Polson et al., Journal of Chromatography B 785:263-275 (2003), describes protein precipitation methods suitable for use in the methods of the present teachings. Protein precipitation may be used to precipitate many, and preferably all, of the proteins from the sample leaving vitamin D metabolites soluble in the supernatant. The samples can be centrifuged to separate the liquid supernatant from the precipitated proteins. The resultant supernatant can then be applied to liquid chromatography and subsequent mass spectrometry analysis.

In one embodiment of the present teachings, the protein precipitation involves adding one volume of the liquid sample (e.g. plasma) to about four volumes of methanol. In certain embodiments, the use of protein precipitation obviates the need for high turbulence liquid chromatography (“HTLC”) or on-line extraction prior to HPLC and mass spectrometry. Accordingly in such embodiments, a sample of interest can undergo protein precipitation followed by loading the supernatant directly onto an HPLC-MS/MS instrument without using on-line extraction or high turbulence liquid chromatography (“HTLC”).

With continued reference to the flow chart of FIG. 1, the processed sample can be subjected to chromatography, preferably liquid chromatography such as high performance liquid chromatograph (HPLC), to separate vitamin D metabolites of interest, such as 25-hydroxyvitamin D₂ and/or 25-hydroxyvitamin D₃, from other components of the sample, thereby preparing the sample for introduction into a mass spectrometer.

The use of HPLC for sample preparation prior to mass spectrometric analysis has been described in the art. For example, Taylor et al., Therapeutic Drug Monitoring (22:608-12 (2000)) disclose manual precipitation of blood samples, followed by manual C18 solid phase extraction, injection into an HPLC for chromatography on a C18 analytical column, and MS/MS analysis. As another example, Salm et al., Clin. Therapeutics (22 Supl. B:B71-B85 (2000)) disclose manual precipitation of blood samples, followed by manual C18 solid phase extraction, injection into an HPLC for chromatography on a C18 analytical column and MS/MS analysis. The chromatographic column typically includes a medium (i.e., a packing material) to facilitate separation of chemical moieties (i.e., fractionation). The medium may include minute particles. The particles can include a bonded surface that interacts with the various chemical moieties to facilitate separation of the chemical moieties such as vitamin D metabolites. One suitable bonded surface is a hydrophobic bonded surface such as an alkyl bonded surface. Alkyl bonded surfaces may include C-4, C-8, or C-18 bonded alkyl groups, preferably C-18 bonded groups. The chromatographic column includes an inlet port for receiving a sample and an outlet port for discharging an effluent that includes the fractionated sample, which can be introduced into a mass spectrometer. In some embodiments, a sample of interest, e.g., a biological sample, that has undergone a processing step such as those discussed above, can be applied to the column at the inlet port, eluted with a solvent or solvent mixture, and discharged at the outlet port. Different solvent modes may be selected for eluting the analytes of interest. For example, liquid chromatography may be performed using a gradient mode, an isocratic mode, or a polytypic (i.e., mixed) mode. In preferred embodiments, HPLC is performed on a multiplexed analytical HPLC system with a C-18 solid phase using isocratic separation with 100% methanol as the mobile phase.

In some embodiments, high turbulence liquid chromatography (HTLC), also known as high throughput liquid chromatography, can be employed for sample preparation prior to analysis by mass spectrometry. See, e.g., Zimmer et al., J. Chromatogr. A 854:23-35 (1999); see also U.S. Pat. Nos. 5,968,367; 5,919,368; 5,795,469; and 5,722,874. Traditional HPLC analysis relies on column packings in which laminar flow of the sample through the column is the basis for separation of the analyte of interest from the sample. The skilled artisan will understand that separation in such columns is a diffusional process. In contrast, it is believed that turbulent flow, such as that provided by HTLC column and methods, may enhance the rate of mass transfer, improving the separation characteristics. In some embodiments, high turbulence liquid chromatography (HTLC), alone or in combination with one or more purification methods, may be used to purify the vitamin D metabolites of interest prior to spectrometry. In such embodiments, samples may be extracted using an HTLC extraction cartridge which captures the analyte, then eluted and chromatographed on a second HTLC column or onto an analytical HPLC column prior to ionization. In some embodiments, such chromatographic procedures can be performed in an automated fashion. In certain embodiments of the method, samples are subjected to protein precipitation as described above prior to loading the sample onto the HTLC column. In other embodiments, the samples may be loaded directly onto the HTLC without being subjected to protein precipitation.

It is known that epimerization of the hydroxyl group of the A-ring of vitamin D₃ metabolites can be an important aspect of vitamin D₃ metabolism and bioactivation, and that depending on the cell types involved, 3-C epimers of vitamin D₃ metabolites (e.g., 3-epi-25(OH)D3; 3-epi-24,25(OH)₂D₃; and 3-epi-1,25(OH)₂D₃) are often major metabolic products. See, Kamao et al., J. Biol. Chem., 279:15897-15907 (2004). Kamao et al. further provides methods for separating various vitamin D metabolites, include 3-C epimers, using chiral HPLC.

In some embodiments, the present teachings can be employed to detect the presence, absence and/or amount of a specific epimer of one or more vitamin D metabolites, such as vitamin D₃ metabolites, in a sample. For example, a sample under study can be processed via chiral HPLC to separate epimers of a vitamin D metabolite of interest, and mass spectrometry can be utilized to detect, and quantify, the epimer of interest. By way of example, chiral HPLC can be used to separate 25(OH)D₃ from 3-epi-25(OH)D3, if present in a sample. Mass spectrometry can then be employed to detect, and optionally quantify, at least one of the epimers in the sample. In another embodiment, chiral chromatography can be used to separate 1α, 25(OH)2D3 from 3-epi-25(OH)2D3, if present in a sample, and subsequently mass spectrometry can be employed to detect at least one of the epimers. Further, in some embodiments, a combination of chiral chromatography and HTLC can be used to process a sample.

With continued reference to the flow chart of FIG. 1, the eluant of the LC module is introduced into a tandem mass spectrometer. The mass spectrometer can include an ion source for ionizing the sample and thereby generating molecular ions for further analysis, as discussed in more detail below. A variety of ionization methods and sources can be employed. Some examples of suitable ionization methods include, without limitation, electrospray ionization (ESI), atmospheric pressure chemical ionization (APCI), photoionization, electron ionization, fast atom bombardment (FAB)/liquid second ionization (LSIMS), matrix assisted laser desorption ionization (MALDI), field ionization, field desorption, thermospray/plasmaspray ionization, and particle beam ionization, among others.

In some embodiments, the ionization method is selected so as to generate a protonated molecular ion, preferably an intact protonated molecular ion, of one or more vitamin D metabolites of interest. By way of example, in some embodiments in which the detection of 25-hydroxyvitamin D₃ and/or 25-hydroxyvitamin D₂ is desired, the ionization step results in generating protonated ions of these vitamin D metabolites. For example, in some embodiments, the ionization step results in generating protonated ions of 25-hydroxyvitamin D₃ at a mass-to-charge ration (m/z) of 401.3±0.3 and protonated ions of 25-hydroxyvitamin D₂ at an m/z of 413±0.3. By way of example, electrospray ionization can be employed to generate such protonated molecular ions. In some embodiments, the ionization step is selected so as to generate protonated molecular ions of both 25-hydroxyvitamin D₃ and 25-hydroxyvitamin D2 so that both of these vitamin D metabolites can be detected, if present in a sample under study, in a single assay.

Subsequent to the formation of the molecular ions of the vitamin D metabolite(s) of interest, the generated molecular ions can be detected and analyzed to determine the presence, and optionally the amount, of the metabolite of interest in a sample. Some suitable mass analyzers include, without limitation, quadrupole analyzers, ion trap analyzers, and time-of-flight analyzers. The ions may be detected using several detection modes. For example, selected ions may be detected using a selective ion monitoring mode (SIM), or alternatively, ions may be detected using a scanning mode, e.g., multiple reaction monitoring (MRM) or selected reaction monitoring (SRM).

In this embodiment, tandem mass spectroscopy (MS/MS) an be used for such analysis. In particular, with reference to the flow chart of FIG. 1, subsequent to ionization of the sample, a protonated molecular ion of interest, for example, a protonated molecular ion having an m/z of 401.3±0.3 and/or protonated molecular ion having an m/z of 413.3±0.3 can be selected for further analysis, as discussed in more detail below. For example, one or more quadrupole mass filters can be employed to select the molecular ion of interest. As known in the art, in a quadrupole mass filter, ions are subjected to electromagnetic forces via interaction with oscillating radio frequency (RF) and DC fields generated by application of electrical signals to the quadrupole rods. The electrical signals applied to the rods, e.g., the amplitude and frequency of the RF signals, can be selected so that only ions having desired m/z values would travel along the length of the quadrupole filter and exit the filter while other ions are deflected, e.g., to strike the rods.

With continued reference to the flow chart of FIG. 1, the selected protonated molecular ions (herein also referred to as the parent ions) are then fragmented to generate one or more fragment ions (herein also referred to as the daughter or product ions). More specifically, in this embodiment, the protonated molecular ions of 25-hydroxyvitamin D₃ at m/z of 401.3±0.3 and/or protonated molecular ions of 25-hydroxyvitamin D₂ at an m/z of 413.3±0.3 are transmitted into a collision cell in which they are fragmented via collision with atoms of an inert gas to generate fragment ions.

The fragment ions are then transmitted into a downstream analyzer, which can select a fragment ion of interest based on its mass-to-charge ratio for detection via a downstream ion detector. For example, in this embodiment, the fragment ion of the protonated 25-hydroxyvitamin D₃ at m/z of 257.2±0.3 and/or the fragment ion of the protonated 25-hydroxyvitamin D₂ at m/z of 133.1±0.3 can be selected by the downstream analyzer. By way of example, one or more quadrupole mass filters disposed downstream of the collision cell can be employed to select these specific fragment ions and transmit these fragment ions to a downstream ion detector for detection while deflecting fragment ions at other m/z ratios. Thus, in this embodiment, the 401.3±0.3/257.2±0.3 MRM transition is employed to detect the presence of 25-hydroxyvitamin D₃ and the 413±0.3/133.1±0.3 MRM transition is employed to detect the presence of 25-hydroxyvitamin D₂ in a sample under study. In some embodiments, the downstream filter is configured to allow selective passage of both fragment ions at m/z ratios of 257.2±0.3 and 133.1±0.3 so as to allow the detection of both 25-hydroxyvitamin D₃ and 25-hydroxyvitamin D₂ in a single run of the spectrometer.

The monitoring of the above MRM transitions for the detection of 25-hydroxyvitamin D₃ and 25-hydroxyvitamin D₂ can advantageously reduce, and preferably eliminate, the interference of other substances in the sample.

In some embodiments, in addition to detecting one or more vitamin D metabolites of interest in a sample, if present, the relative and/or absolute amount of the metabolite(s) can be determined. For example, a mass spectrum can be related to the amount of the metabolite of interest in the original sample using a variety of methods known in the arts. For example, in some cases, calibration tables can be used to convert a relative abundance of a detected ion associated with a metabolite to an absolute amount of the metabolite in the original sample. In some embodiments, molecular standards can be run with a sample of interest, and a standard curve constructed based on ions generated from those standards can be used to convert a relative abundance of an ion associated with an analyte of interest (e.g., a fragment ion associated with a vitamin D metabolite) to the absolute amount of the analyte in the sample.

In some embodiments, an internal standard can used to generate a standard curve for calculating the quantity of a vitamin D metabolite of interest, e.g., 25-hydroxyvitamin D₃ and/or 25 hydroxyvitamin D₂. Methods for generating and using such standard curves are well known in the art and one of ordinary skill is capable of selecting an appropriate internal standard. For example, an isotope of a vitamin D metabolite may be used as an internal standard. By way of example, the internal standard can be a deuterated vitamin D metabolite. For example, in some embodiments, D₆-25-hydroxyvitamin D₃ and/or D6-25-hydroxyvitamin D₂ can be employed as internal standards for quantifying the amount of 25-hydroxyvitamin D₃ and/or 25-hydroxyvitamin D₂ in a sample of interest, e.g., a biological sample. Other methods for quantifying the amount of a vitamin D metabolite in a sample based on the detection of fragment ions discussed above can be also be used.

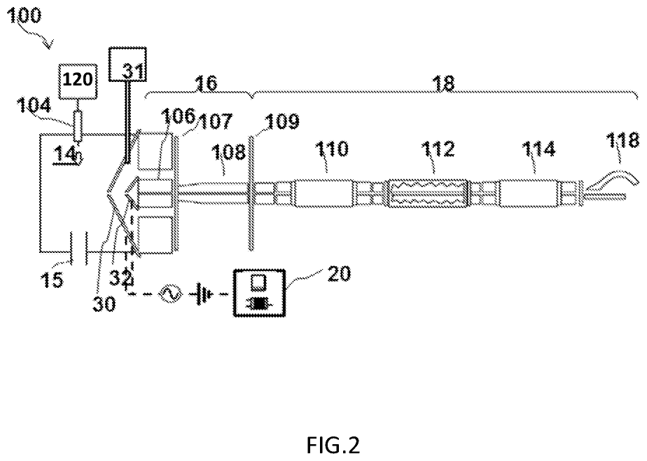

While the systems, devices, and methods described herein can be used in conjunction with many different mass spectrometer systems, an exemplary mass spectrometer system 100 for such use is illustrated schematically in FIG. 2. It should be understood that the mass spectrometer system 100 represents only one possible mass spectrometer instrument for use in accordance with embodiments of the systems, devices, and methods described herein, and mass spectrometers having other configurations can all be used in accordance with the systems, devices and methods described herein as well.

As shown schematically in the exemplary embodiment depicted in FIG. 2, the mass spectrometer system 100 generally comprises a triple quadrupole (QqQ) mass spectrometer, modified in accordance with various aspects of the present teachings. Other non-limiting, exemplary mass spectrometer systems that can be modified in accordance various aspects of the systems, devices, and methods disclosed herein can be found, for example, in an article entitled “Product ion scanning using a Q-q-Qₗᵢₙₑₐᵣ ion trap (Q TRAP®) mass spectrometer,” authored by James W. Hager and J. C. Yves Le Blanc and published in Rapid Communications in Mass Spectrometry (2003; 17: 1056-1064), and U.S. Pat. No. 7,923,681, entitled “Collision Cell for Mass Spectrometer,” which are hereby incorporated by reference in their entireties. Other configurations, including but not limited to those described herein and others known to those skilled in the art, can also be utilized in conjunction with the systems, devices, and methods disclosed herein. For instance other suitable mass spectrometers include single quadrupole, triple quadrupole, ToF, trap, and hybrid analyzers.

As shown in FIG. 2, the exemplary mass spectrometer system 100 comprises an ion source 104 for generating ions within an ionization chamber 14, an upstream section 16 for initial processing of ions received therefrom, and a downstream section 18 containing one or more mass analyzers (e.g., Q1 and Q3), a collision cell (e.g., q2), and a detector 118. Ions generated by the ion source 104 can be successively transmitted through the elements of the upstream section 16 (e.g., curtain plate 30, orifice plate 32, Qjet 106, and Q0 108) to result in a narrow and highly focused ion beam (e.g., in the z-direction along the central longitudinal axis) for further mass analysis within the high vacuum downstream portion 18.

In the depicted embodiment, the ionization chamber 14 can be maintained at atmospheric pressure, though in some embodiments, the ionization chamber 14 can be evacuated to a pressure lower than atmospheric pressure. The curtain chamber (i.e., the space between curtain plate 30 and orifice plate 32) can also be maintained at an elevated pressure (e.g., about atmospheric pressure, a pressure greater than the upstream section 16), while the upstream section 16, and downstream section 18 can be maintained at one or more selected pressures (e.g., the same or different sub-atmospheric pressures, a pressure lower than the ionization chamber) by evacuation through one or more vacuum pump ports (not shown). The upstream section 16 of the mass spectrometer system 100 is typically maintained at one or more elevated pressures relative to the various pressure regions of the downstream section 18, which typically operate at reduced pressures so as to promote tight focusing and control of ion movement.

The ionization chamber 14, within which analytes contained within the fluid sample discharged from the ion source 104 can be ionized, is separated from a gas curtain chamber by a curtain plate 30 defining a curtain plate aperture in fluid communication with the upstream section via the sampling orifice of an orifice plate 32. In accordance with various aspects of the present teachings, a curtain gas supply 31 can provide a curtain gas flow (e.g., of N₂) between the curtain plate 30 and orifice plate 32 to aid in keeping the downstream section of the mass spectrometer system clean by declustering and evacuating large neutral particles. By way of example, a portion of the curtain gas can flow out of the curtain plate aperture into the ionization chamber 14, thereby preventing the entry of droplets through the curtain plate aperture. Additionally, as discussed in detail below, curtain gas outflow (e.g., from the curtain gas into the ionization chamber 14 via the curtain plate aperture) can provide a barrier to ionized species that can be overcome in accordance with some aspects of the present teachings by modulating the electric field within the curtain gas chamber. Curtain gas can flow counter-current in at least a portion of the curtain chamber and ions may drift through the curtain gas flow as a result of the electric field between the curtain plate 30 and orifice plate 32. In such aspects, the curtain gas flow provided to the curtain chamber can be greater than the vacuum drag through the sampling orifice of the orifice plate 32. In some embodiments, the electric field generated within the curtain chamber can be eliminated such that a counter-current curtain gas flow can provide a pneumatic block of ions and/or neutrals from traversing the curtain chamber and/or the field may be inverted to provide both a pneumatic and an electrical block of ions.

As discussed in detail below, the mass spectrometer system 100 also includes a power supply and controller 20 that can be coupled to the various components so as to operate the mass spectrometer system 100 to reduce the ion flux transmitted into the downstream high-vacuum section 18 (e.g., during non-analytical periods) in accordance with various aspects of the present teachings. In this manner, the system 100 can provide for reduced ion contamination of the various components, and in particular, those components of the high-vacuum section 18 so as to improve performance and/or reduce the frequency of cleaning of this section.

As shown, the depicted system 100 includes a sample source 102 configured to provide a fluid sample to the ion source 104. The sample source 102 can be any suitable sample inlet system known to one of skill in the art and can be configured to contain and/or introduce a sample (e.g., a liquid sample containing or suspected of containing an analyte of interest) to the ion source 104. The sample source 102 can be fluidly coupled to the ion source so as to transmit a liquid sample to the ion source 104 (e.g., through one or more conduits, channels, tubing, pipes, capillary tubes, etc.). In this embodiment, the sample can be delivered to the ion source 104 by an in-line liquid chromatography (LC) column (not shown).

The ion source 104 can have a variety of configurations but is generally configured to generate ions from analytes contained within a sample (e.g., a fluid sample that is received from the sample source 102). In the exemplary embodiment depicted in FIG. 2, the ion source 104 comprises an electrospray electrode, which can comprise a capillary fluidly coupled to the sample source 102 and which terminates in an outlet end that at least partially extends into the ionization chamber 14 to discharge the liquid sample therein. As will be appreciated by a person skilled in the art in light of the present teachings, the outlet end of the electrospray electrode can atomize, aerosolize, nebulize, or otherwise discharge (e.g., spray with a nozzle) the liquid sample into the ionization chamber 14 to form a sample plume comprising a plurality of micro-droplets generally directed toward (e.g., in the vicinity of) the curtain plate aperture. As is known in the art, analytes contained within the micro-droplets can be ionized (i.e., charged) by the ion source 104, for example, as the sample plume is generated. In some aspects, the outlet end of the electrospray electrode can be made of a conductive material and electrically coupled to a power supply (e.g., voltage source) operatively coupled to the controller 20 such that as fluid within the micro-droplets contained within the sample plume evaporate during desolvation in the ionization chamber 14, bare charged analyte ions or solvated ions are released and drawn toward and through the curtain plate aperture. In some alternative aspects, the discharge end of the sprayer can be non-conductive and spray charging can occur through a conductive union or junction to apply high voltage to the liquid stream (e.g., upstream of the capillary). Though the ion source 104 is generally described herein as an electrospray electrode, it should be that appreciated that any number of different ionization techniques known in the art for ionizing analytes within a sample and modified in accordance with the present teachings can be utilized as the ion source 104. By way of non-limiting example, the ion source 104 can be an electrospray ionization device, a nebulizer assisted electrospray device, a chemical ionization device, a nebulizer assisted atomization device, a matrix-assisted laser desorption/ionization (MALDI) ion source, a photoionization device, a laser ionization device, a thermospray ionization device, an inductively coupled plasma (ICP) ion source, a sonic spray ionization device, a glow discharge ion source, and an electron impact ion source, DESI, among others. Further, as shown in FIG. 1, the ion source 104 can be disposed orthogonally relative to the curtain plate aperture and the ion path axis such that the plume discharged from the ion source 104 is also generally directed toward an exhaust port 15 of the ionization chamber 14. In this manner, liquid droplets and/or large neutral molecules that are not drawn into the curtain chamber 30 via the curtain plate orifice can be removed from the ionization chamber 14 so as to prevents accumulation and/or recirculation of the potential contaminants within the ionization chamber. In various aspects, a nebulizer gas can also be provided (e.g., about the discharge end of the ion source 104) to prevent the accumulation of droplets on the sprayer tip and/or direct the sample plume in the direction of the curtain plate aperture.

In this embodiment, the ion source can be an electrospray ion source that is configured to generate protonated molecular ions of vitamin D metabolites of interest. For example, the ion source can generate a protonated molecular ion of 25-hydroxy vitamin D₃ having an m/z of 401.3±0.3, and generate a protonated molecular ion of 25-hydroxy vitamin D₂ having an m/z of 413.3±0.3. In some embodiments in which internal standards are employed for quantifying the amount of one or more vitamin D metabolites of interest, the ion source can generate molecular ions of such standards. By way of example, in some embodiments in which D₆-25-hydroxy vitamin D₃ is employed as a standard, the ion source can generate a protonated molecular ion of this standard having an m/z of 407.3±0.3.

In some embodiments, upon passing through the orifice plate 32, the ions can traverse one or more additional vacuum chambers and/or quadrupoles (e.g., a QJet® quadrupole) to provide additional focusing of and finer control over the ion beam using a combination of gas dynamics and radio frequency fields prior to being transmitted into the downstream high-vacuum section 18. In accordance with various aspects of the present teachings, it will also be appreciated that the exemplary ion guides described herein can be disposed in a variety of front-end locations of mass spectrometer systems. By way of non-limiting example, the ion guide 108 can serve in the conventional role of a QJet® ion guide (e.g., operated at a pressure of about 1-10 Torr), as a conventional Q0 focusing ion guide (e.g., operated at a pressure of about 3-15 mTorr) preceded by a QJet® ion guide, as a combined Q0 focusing ion guide and QJet® ion guide (e.g., operated at a pressure of about 3-15 mTorr), or as an intermediate device between the QJet ion guide and Q0 (e.g., operated at a pressure in the 100 s of mTorrs, at a pressure between a typical QJet® ion guide and a typical Q0 focusing ion guide).

As shown, the upstream section 16 of system 100 is separated from the curtain chamber via orifice plate 32 and generally comprises a first RF ion guide 106 (e.g., Qjet® of SCIEX) and a second RF guide 108 (e.g., Q0). In some exemplary aspects, the first RF ion guide 106 can be used to capture and focus ions using a combination of gas dynamics and radio frequency fields. By way of example, ions can be transmitted through the sampling orifice, where a vacuum expansion occurs as a result of the pressure differential between the chambers on either side of the orifice plate 32. By way of non-limiting example, the pressure in the region of the first RF ion guide can be maintained at about 2.5 Torr pressure. The Qjet 106 transfers ions received thereby to subsequent ion optics such as the Q0 RF ion guide 108 through the ion lens IQ0 107 disposed therebetween. The Q0 RF ion guide 42 transports ions through an intermediate pressure region (e.g., in a range of about 1 mTorr to about 10 mTorr) and delivers ions through the IQ1 lens 109 to the downstream section 18 of system 100.

The downstream section 18 of system 100 generally comprises a high vacuum chamber containing the one or more mass analyzers for further processing of the ions transmitted from the upstream section 16. As shown in FIG. 2, the exemplary downstream section 18 includes two mass analyzers 110, 114 (e.g., elongated rod sets Q1 and Q3) and a third elongated rod set q2 112 disposed therebetween that can be operated as a collision cell (rod sets Q1, q2, and Q3 are separated by orifice plates IQ2 between Q1 and q2, and IQ3 between q2 and Q3), as well as a detector 118, though more or fewer mass analyzer elements can be included in systems in accordance with the present teachings.

For example, after being transmitted from Q0 through the exit aperture of the lens IQ1, ions can enter the adjacent quadrupole rod set Q1, which can be situated in a vacuum chamber that can be evacuated to a pressure that can be maintained lower than that of chamber in which RF ion guide 108 is disposed. By way of non-limiting example, the vacuum chamber containing Q1 can be maintained at a pressure less than about 1×10⁻⁴ Torr (e.g., about 5×10⁻⁵ Torr), though other pressures can be used for this or for other purposes. As will be appreciated by a person of skill in the art, the quadrupole rod set Q1 can be operated as a conventional transmission RF/DC quadrupole mass filter that can be operated to select an ion of interest and/or a range of ions of interest. By way of example, the quadrupole rod set Q1 can be provided with RF/DC voltages suitable for operation in a mass-resolving mode. As should be appreciated, taking the physical and electrical properties of Q1 into account, parameters for an applied RF and DC voltage can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. In particular, in this embodiment, the RF and DC voltages applied to the rods of the quadrupole rod set Q1 are configured so as to select one or more protonated molecular ions of one or more vitamin D metabolites of interest. By way of example, the quadrupole rod set Q1 can be used to select protonated molecular ions of 25-hydroxy vitamin D₃ having an m/z of 401.3±0.3 and/or select protonated molecular ions of 25-hydroxy vitamin D₂ having an m/z of 413±0.3. Further, in embodiments in which internal standards are employed, the quadrupole rod set Q1 can select molecular ions of such standards generated in the ion source.

Ions passing through the quadrupole rod set Q1 (e.g., molecular ions of vitamin D metabolites of interest), can pass through the lens IQ2 and into the adjacent quadrupole rod set q2, which as shown can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to fragment ions in the ion beam.

In some embodiments of the present teachings, the fragmentation of the protonated molecular ions of the vitamin D metabolites can result in fragment ions that do not represent water losses from the protonated precursor molecular ions. By way of example, the fragmentation of protonated 25-hydroxy vitamin D₃ can result in fragment ions having an m/z of 257.2±0.3, or 121.1±0.3, or 133.1±0.3, or 147.1±0.3, and the fragmentation of protonated 25-hydroxy vitamin D₂ can result in fragment ions having an m/z of 271.2±0.3, or 121.1±0.3, or 173.1±0.3 or 147.1±0.3. As discussed in more detail below, the detection of one or more of these fragment ions can be employed to identify the presence of 25-hydroxy vitamin D₃ and/or 25-hydroxy vitamin D₂ in the sample under study.

The fragment ions that are transmitted by q2 can pass into the adjacent quadrupole rod set Q3, which is bounded upstream by IQ3 and downstream by an exit lens. As will be appreciated by a person skilled in the art, the quadrupole rod set Q3 can be operated at a decreased operating pressure relative to that of q2, for example, less than about 1×10⁻⁴ Torr (e.g., about 5×10⁻⁵ Torr), though other pressures can be used for this or for other purposes. In this embodiment, the quadrupole rod set Q3 can be operated as a mass filter so as to select one or more ion fragments of interest. In particular, the quadrupole rod set Q3 can be configured to allow passage of one or more fragment ions corresponding to the fragmentation of the protonated molecular ions of vitamin D metabolites of interest. For example, the quadrupole rod set Q3 can be configured to selectively allow passage of fragment ions having an m/z ratio of 257.2, or 121.1, or 133.1, or 147.1, or 271.2, or 121.1, or 173.1 or 147.1. For example, the quadrupole rod sets Q1 and Q3 can be configured to select the intact protonated molecular ion of 25-hydroxy vitamin D₃ at an m/z of 401.3±0.3 and its fragment ion at an m/z of 257.2±0.3 and concurrently the intact protonated molecular ion of 25-hydroxyvitamin D₂ at an m/z of 413.3±0.3 and its fragment ion at an m/z of 271.2±0.3. In other words, in some embodiments, the quadrupole rod sets Q1 and Q3 can be configured so as to detect the 401.3/257.2 MRM transition for identifying 25-hydroxy vitamin D₃ and to detect the 413.3±0.3/271.2±0.3 MRM transition for identifying 25-hydroxy vitamin D₂ in a sample of interest. Other MRM transitions according to the present teachings can also be utilized. For example, a 401.3/121.1 MRM transition can be used to identify 25-hydroxyvitamin D₃.

Following transmission of the fragment ions through Q3, the fragment ions can be transmitted onto the detector 118 through the exit lens. The detector 118 can then be operated in a manner known to those skilled in the art in view of the systems, devices, and methods described herein. As will be appreciated by a person skill in the art, any known detector, modified in accord with the teachings herein, can be used to detect the ions. It will also be appreciated by those skilled in the art that the downstream section 18 can additionally include additional ion optics, including RF-only stubby ion guides (which can serve as a Brubaker lens) as schematically depicted. Typical ion guides of ion guide regions Q0, Q1, q2 and Q3 and stubbies ST1, ST2 and ST3 in the present teachings, can include at least one electrode as generally known in the art, in addition to ancillary components generally required for structural support. For convenience, the mass analyzers 110, 114 and collision cell 112 are generally referred to herein as quadrupoles (that is, they have four rods), though the elongated rod sets can be any other suitable multipole configurations, for example, hexapoles, octapoles, etc. It will also be appreciated that the one or more mass analyzers can be any of triple quadrupoles, single quadrupoles, time of flights, linear ion traps, quadrupole time of flights, Orbitrap or other Fourier transform mass spectrometers, all by way of non-limiting example.

In some embodiments, matrix-assisted desorption ionization can be employed for ionizing one or more vitamin D metabolites of interest. Further in some embodiments, tandem mass spectroscopy with more than two mass analyzers can be employed. Other options for performing mass spectroscopy in accordance with the present teachings include MS/MS/TOF (time-of-flight), MALD/MS/MS/TOF, etc.

In some embodiments, the present teachings can be implemented using automated machines. Further, as noted above, in many embodiments, the vitamin D metabolites of interest can be detected without derivatization, though in some embodiments derivatization may be employed.

In some embodiments, various kits can be utilized to carry out embodiments of the present invention. The kit can comprise two or more standards selected from the group consisting of 25-hydroxyvitamin D₃, 25-hydroxyvitamin D₂, 1,25-dihydroxyvitamin D₃ and 1,25-dihydroxyvitamin D₂ with known concentration. The kit can comprise an isotopic version of at least one of the two or more standards having known concentrations. The kit can comprise a pentafluorophenyl liquid chromatrographic column. The kit can comprise one or more solvents. The kit can comprise a system suitability mixture comprising a known concentration of 25-OH-Vitamin D₃, a known concentration of 25-OH-Vitamin D₂ and a known concentration of 3-epi-25-OH-Vitamin D₃. The kit can comprise instructions for carrying out various methods described herein.

The methods within can be carried out by use of a kit. The kit contains, two or more calibrators, each containing two or more standards selected from the group consisting of 25-hydroxyvitamin D₃, 25-hydroxyvitamin D₂, 1,25-dihydroxyvitamin D₃ and 1,25-dihydroxyvitamin D₂ with known concentration. Each calibrator has one or more standard (preferably at least two) at a known concentration. For example, three kit calibrators can contain 25-hydroxyvitamin D₃ concentrations of 10 nM, 25 nM and 50 nm, respectively. Alternatively, or in addition to, these three calibrators can contain both 25-hydroxyvitamin D₃ and 25-hydroxyvitamin D₂, each at 10 nM, 25 nM and 50 nM, respectively. These calibrators can be utilized in creating a calibration curve.

In addition, the kit contains an isotopic version of the one or more standards having known concentrations. The isotopic version of the one or more standards is a similar to the non-isotopic version however, one or more atoms has been replaced with a stable isotopic version of the atom having a higher or lower mass. For example, one or more atoms of hydrogen in the standard can be replaced with deuterium. Alternatively, one or more atoms of ¹²C can be replaced with ¹³C.

In addition, the kit can contain a pentafluorophenyl liquid chromatographic column useful in performing separation of an analyte mixture. The kit may also contain one or more solvents that can be utilized to effect a separation in the liquid chromatographic column. The kit may also contain a system suitability mixture comprising a known concentration of 25-OH-Vitamin D₃, a known concentration of 25-OH-Vitamin D₂ and a known concentration of 3-epi-25-OH-Vitamin D₃. For example, the system suitability mixture may contain 30 ng/mL of 25-OH-Vitamin D₃, 10 ng/mL of 3-epi-25-OH-Vitamin D₃ and 30 ng/mL 25-OH-Vitamin D₂. The system suitability mixture is a test mixture that can be utilized to determine the readiness of a liquid chromatography mass spectrometry system to perform that methods described in the within teachings. This mixture is a solution that can be directly injected onto the LC/MS system requiring no sample preparation that ensures that the entire system is operating correctly before analyzing other samples. After the system suitability mixture is injected and analyzed, a report can be generated the indicates whether all the specifications of the system meet the necessary requirements. For example, requirements can be to determine if the peaks fall within the desired retention time window, determine if the intensities of the peaks are high enough, and whether the 3-epi-25-OH-vitamin D₃ is separated sufficiently from 25-OH-vitamin D3.

The following examples are provided for further elucidation of various aspects of the present teachings, and are not intended as necessarily indicating the optimal ways of practicing the present teachings and/or optimal results that can be obtained. The Examples are hence provided only for illustrative purposes.

### EXAMPLES

### Example 1

Sample Preparation

A 200 μL aliquot of methanol containing 25 ng/mL of d6-25-hydroxyvitamin D₃ (d6-25(OH)D3) and a 25 μL aliquot of a 5% aqueous zinc sulfate solution (wt/wt) were added to 100 μL aliquot of serum in order to precipitate proteins and incorporate an internal standard into the sample preparation workflow. The resultant mixture was vortexed for 1 minute, incubated for 10 minutes at 2-8° C. and then centrifuged at room temperature for 5 minutes at 15,000×g. A 200 μL aliquot of the supernatant was transferred to a HPLC vial that was loaded onto the autosampler of the LC-MS/MS system.

Instrumentation and Analytical Method

The LC subsystem of the LC-MS/MS system was a Shimadzu Prominence LC with a CTO-30A column oven equipped with three valves that enabled 2D LC capabilities. The 2D LC method used a 20×2.1 mm pentafluorophenyl trap column and a 100×2.1 mm pentafluorophenyl (PFP) analytical column, wherein the latter was heated to 40° C. The temperature of the autosampler of the LC subsystem was kept at 15° C. throughout the analytical run. Mobile phase A was 70% water and 30% methanol with 0.1% formic acid and mobile phase B was 80% methanol and 20% water with 0.1% formic acid. In preparation for each 40 μL sample injection, the 2D LC valve system was set so that the trap column was in-line with the autosampler injection port and the pump line carrying mobile phase A at 2.25 mL/min and the analytical column was only in-line with the pump line carrying mobile phase B at 0.6 mL/min. Upon injection under these conditions, target analytes were bound to the trap column and interfering compounds were washed away to waste. After 0.9 minutes of washing, the 2D LC valve system and pump flows changed according to the program in table 1. This program allowed bound analytes to elute from the trap column onto the analytical column for isocratic separation of 3-epi-25-hydroxyvitamin D₃ (3-epi-25(OH)D3) and 25-hydroxyvitamin D₃ (25(OH)D3). After 6 minutes the valves and pumps of the LC system reverted to pre-injection conditions to equilibrate the system for the next injection.

TABLE 1
The LC pump program used for separation of 3-epi-25(OH)D₃ and
25(OH)D₃ with trap and analytical column on the 2D LC system.

| Start | End | A flow | B flow | |
|---|---|---|---|---|
| time | time | rate | rate | Valve/Pump |
| (min) | (min) | (mL/min) | (mL/min) | configuration |
| 0 | 0.9 | 2.25 | 0.6 | Mobile phase A flowing |
| | | | | through the trap column and |
| | | | | auto sampler, mobile |
| | | | | phase B flowing through the |
| | | | | analytical column |
| 0.9 | 1.4 | 0.63 | 0.07 | Mobile phase A and B |
| | | | | mixing and flowing through |
| | | | | analytical column, trap column |
| | | | | held of-line from pumps |
| 1.4 | 5.0 | 0.24 | 0.46 | Mobile phase A and B mixing and |
| | | | | flowing through trap and then |
| | | | | analytical column |

Over the course of the LC run, separated analytes eluted from the analytical column into the ESI ion source of a Sciex 4500 MD tandem mass spectrometer subsystem operated in positive ion mode using multiple-reaction-monitoring (MRM) for measuring 25-hydroxyvitamin D₂ (25(OH)D₂), 25(OH)D₃ and d6-25(OH)D3. The source and MRM parameter settings are listed in tables 2 and 3, respectively. Two MRM transitions, QUANT and QUAL, were monitored for each 25(OH)D₃ and 25(OH)D₂ in all samples. MultiQuant was used to generate peak areas for all MRM transition traces with the smoothing parameter set to 1. Ratios of QUANT/IS peak areas and known concentrations of the calibrators were used to construct calibration curves. The calibration curves enabled the calculation of amounts of 25(OH)D3 and 25(OH)D2 in test samples using their respective QUANT/IS peak area ratios. QUAL/QUANT ratios for the test samples were used to test the verity of the detected peaks by comparing the ratios to the average of the same ratios calculated from the calibrators. The concentrations measured in the QC samples were compared to their pre-determined concentrations in order to verify the quality of the sample preparation and analytical run.

TABLE 2
The ESI source settings for the 25(OH)D3
and 25(OH)D2 LC-MS/MS analytical method.

| Parameter | setting |
|---|---|
| Ionspray Voltage (+V) | 5000 |
| Gas 1 (psi) | 50 |
| Gas 2 (psi) | 60 |
| Temperature (° C.) | 450 |
| Curtain gas | 30 |

TABLE 3
The compound dependent settings for the 25(OH)D3
and 25(OH)D2 LC-MS/MS analytical method.

| MRM | Q1 | Q3 | DP | EP | CE | CXP |
|---|---|---|---|---|---|---|
| 25(OH)D3 Quant | 401.3 | 257.2 | 55 | 10 | 21 | 16 |
| 25(OH)D3 Qual | 401.3 | 121.1 | 60 | 10 | 27 | 11 |
| 25(OH)D2 Quant | 413.3 | 271.2 | 20 | 10 | 16 | 15 |
| 25(OH)D2 Qual | 413.3 | 133.1 | 20 | 10 | 38 | 9 |
| d6-25(OH)D3 | 407.3 | 263.2 | 20 | 10 | 21 | 15 |

Samples

The calibrators were formulated by spiking in known amounts of 25(OH)D3 and 25(OH)D2 into human serum that had been stripped of detectable amount of endogenous 25(OH)D₃ and 25(OH)D₂. The concentration of 25(OH)D₃ and 25(OH)D₂ in the calibrators spanned the range of approximately 4 to 130 ng/mL. The 3 QC samples were prepared in the same way as the calibrators except with a different batch of stripped serum. The concentrations of 25(OH)D₃ and 25(OH)D₂ in the 3 QC samples were approximately 16, 37 and 85 ng/mL. Linearity samples were formulated by preparing a high and low level serum pool and then mixing them in different proportions to generate a 9-level linearity series. The high level serum pool was formulated by spiking amounts of 25(OH)D₃ and 25(OH)D₂ into human serum. The low level serum pool was formulated by spiking amounts of 25(OH)D₃ and 25(OH)D₂ into human serum that had been stripped of detectable amounts of endogenous 25(OH)D₃ and 25(OH)D2. The concentrations of 25(OH)D3 and 25(OH)D2 in the linearity series spanned the range of 2-160 ng/mL.

Linearity and Limits Results

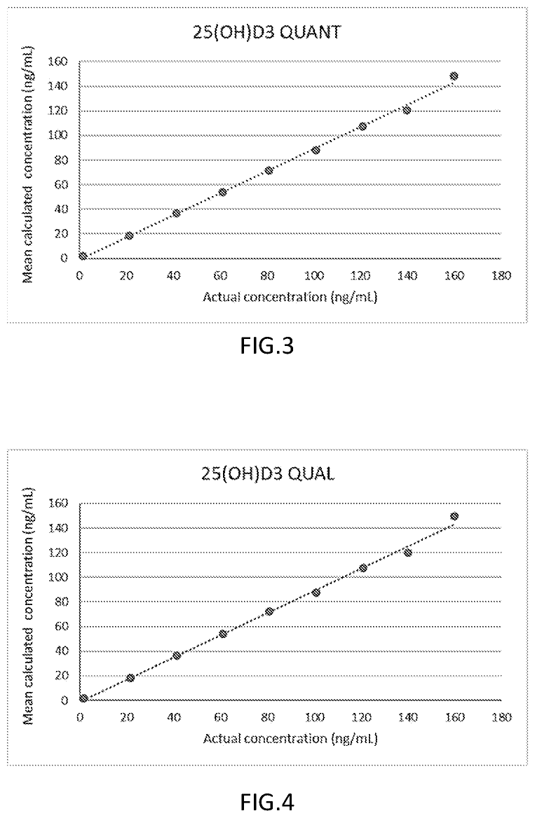

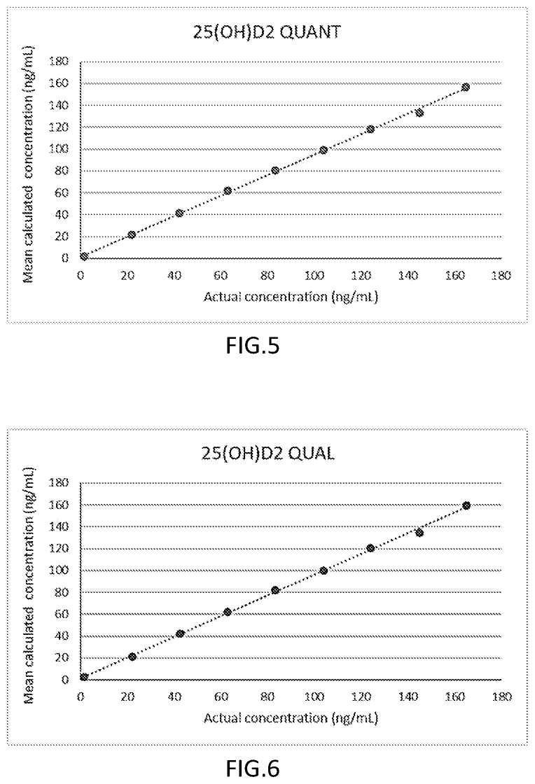

Calibrators, QC and linearity series samples were prepared and injected in duplicate in the following order; the 1^{st} injection of the calibrators and QC samples, the 1^{st} injection of the linearity samples, the 2^{nd} injection of the linearity samples, and the 2^{nd} injection of the calibrators and QC samples. Calibration curves were constructed for 25(OH)D₃ and 25(OH)D₂ from both replicates of the calibrator samples and the linear fit equations were used to calculate the concentrations in the QC and linearity samples. The 3 QC samples for both analytes passed the run acceptance criteria (based on accuracy) indicating that sample preparation and the analytical run were of good quality. The calculated concentrations of the linearity samples are shown in table 4 (25(OH)D₃) and table 5 (25(OH)D₂) and the average of the 2 replicates was plotted versus their spiked concentrations. These plots are shown in FIGS. 3 and 4 for 25(OH)D₃ QUANT and QUAL, respectively, and FIGS. 5 and 6 for 25(OH)D₂ QUANT and QUAL, respectively. All plots showed good linearity as shown by the R² values in tables 4 and 5 (i.e., all R²>0.99). The data shows that the assay was linear over a concentration range that was wider than the calibrator concentration range. Also, the low variability and high accuracy (i.e., % recovery) for level L1 of the linearity series for the QUANT transitions establishes the concentrations in this sample to be the quantitation limits of the assay, which were 1.60 ng/mL for 25(OH)D₃ and 1.65 ng/mL for 25(OH)D2.

TABLE 4
The linearity results for the QUANT and QUAL transitions for 25(OH)D3.

| | 25(OH)D3 Quant (ng/mL) | | | | | 25(OH)D3 Qual (ng/mL) | | | | |
|---|---|---|---|---|---|---|---|---|---|---|
| | | | | Amount | % | | | | Amount | % |
| Level | Inj 1 | Inj 2 | Mean | spiked | recovery | Inj 1 | Inj 2 | Mean | spiked | recovery |
| L1 | 2.10 | 2.00 | 2.05 | 1.60 | 128% | 2.00 | 1.90 | 1.95 | 1.60 | 122% |
| L2 | 18.7 | 18.2 | 18.5 | 21.4 | 86% | 18.1 | 18.9 | 18.5 | 21.4 | 86% |
| L3 | 37.2 | 36.0 | 36.6 | 41.3 | 89% | 36.0 | 37.3 | 36.7 | 41.3 | 89% |
| L4 | 54.2 | 53.7 | 54.0 | 61.1 | 88% | 53.4 | 54.8 | 54.1 | 61.1 | 89% |
| L5 | 72.5 | 70.0 | 71.3 | 80.9 | 88% | 72.3 | 71.9 | 72.1 | 80.9 | 89% |
| L6 | 88.7 | 87.2 | 88.0 | 101 | 87% | 87.4 | 88.0 | 87.7 | 101 | 87% |
| L7 | 107 | 108 | 107 | 121 | 89% | 107 | 108 | 108 | 121 | 89% |
| L8 | 116 | 124 | 120 | 140 | 86% | 119 | 121 | 120 | 140 | 86% |
| L9 | 148 | 149 | 148 | 160 | 93% | 145 | 154 | 150 | 160 | 93% |

| | | |
|---|---|---|
| R² | 0.997 | 0.996 |

TABLE 5
The linearity results for the QUANT and QUAL transitions for 25(OH)D2.

| | 25(OH)D2 Quant (ng/mL) | | | | | 25(OH)D2 Qual (ng/mL) | | | | |
|---|---|---|---|---|---|---|---|---|---|---|
| | | | | Amount | % | | | | Amount | % |
| Level | Inj 1 | Inj 2 | Mean | spiked | recovery | Inj 1 | Inj 2 | Mean | spiked | recovery |
| L1 | 1.80 | 2.00 | 1.90 | 1.65 | 115% | 2.40 | 2.40 | 2.40 | 1.65 | 145% |
| L2 | 20.7 | 22.9 | 21.8 | 22.1 | 99% | 20.7 | 21.5 | 21.1 | 22.1 | 95% |
| L3 | 41.3 | 41.4 | 41.4 | 42.5 | 97% | 42.0 | 42.0 | 42.0 | 42.5 | 99% |
| L4 | 61.7 | 62.1 | 61.9 | 62.9 | 98% | 61.5 | 62.7 | 62.1 | 62.9 | 99% |
| L5 | 82.4 | 78.8 | 80.6 | 83.4 | 97% | 83.5 | 80.8 | 82.2 | 83.4 | 99% |
| L6 | 98.6 | 100 | 99.4 | 104 | 96% | 100 | 98.9 | 99.6 | 104 | 96% |
| L7 | 117 | 120 | 119 | 124 | 96% | 121 | 120 | 120 | 124 | 97% |
| L8 | 128 | 138 | 133 | 145 | 92% | 129 | 139 | 134 | 145 | 93% |
| L9 | 158 | 156 | 157 | 165 | 95% | 160 | 160 | 160 | 165 | 97% |

| | | |
|---|---|---|
| R² | 0.999 | 0.999 |

### Example 2

Calibrators, QC and linearity series samples and a sample were prepared following a similar procedure to that utilized in Example 1 and introduced into an autosampling system maintained at 15° C.

An LC subsystem of the LC-MS/MS comprising a single Phenomenex Kinetex® 2.6 μm pentafluorophenyl 100 Å 100 mm×3 mm LC Column (Part Number 00D-4477-Y0) having a column heater at 40° C. was utilized to effect separation. Mobile Phase A and B are the same as those utilized in Example 1.

A 40 μL sample is injected into the LC system and the flow is modified according to the gradient parameters set out in Table 6 over the course of a 3 min run using a 0.7 mL/min total flow rate to cause a separation.

TABLE 6
LC gradient

| | | | A Flow | B Flow |
|---|---|---|---|---|
| Start Time [min] | A % | B % | [mL/min] | [mL/min] |
| 0 | 22 | 78 | 0.154 | 0.546 |
| 2 | 22 | 78 | 0.154 | 0.546 |
| 2.1 | 10 | 90 | 0.07 | 0.63 |
| 2.6 | 10 | 90 | 0.07 | 0.63 |
| 2.7 | 60 | 40 | 0.42 | 0.28 |
| 2.8 | 60 | 40 | 0.42 | 0.28 |
| 2.81 | 22 | 78 | 0.154 | 0.546 |

Over the course of the LC run, separated analytes eluted from the analytical column an Atmospheric Pressure Chemical Ionization (APCI) source of a SCIEX Topaz™ LC-MS/MS System operated in positive ion mode using the parameters setout in Table 7.

TABLE 7
APCI source and settings for the 25(OH)D3
and 25(OH)D2 LC-MS/MS analytical method.

| Parameter | setting | |
|---|---|---|
| Curtain Gas | 25 | |
| Ion Source Gas 1 (psi) | 50 | |
| Temperature (° C.) | 375 | |
| Nebulizer Current | 3 | |
| CAD Gas | 9 | |
| Q3 Resolution | Unit | |
| Pause Time | 5 | ms |
| Total Scan time | 0.6 | s |

The MRM parameter setting that were used to detect the analytes are listed in Table 8.

TABLE 8
The compound dependent settings for an 25(OH)D3
and 25(OH)D2 LC-MS/MS analytical method.

| | Q1 | Q3 | Declustering | Entrance | Collision | Collision |
|---|---|---|---|---|---|---|
| Compound | Mass | Mass | Potential | Potential | Energy | Cell Exit |
| ID | (Da) | (Da) | (V) | (V) | (V) | (V) |
| 25(OH)-D3 Quant | 401.2 | 257.2 | 80 | 10 | 20 | 19 |
| 25(OH)-D3 Qual | 401.2 | 121.1 | 80 | 10 | 33 | 11 |
| 25(OH)-D2 Quant | 413.2 | 271.2 | 75 | 10 | 20 | 11 |
| 25(OH)-D2 Qual | 413.2 | 133.1 | 75 | 10 | 40 | 9 |
| Internal Std | 407.3 | 263.3 | 80 | 10 | 22 | 11 |
| d6-25(OH)-D3 Quant | | | | | | |
| Internal Std | 407.3 | 121.1 | 80 | 10 | 36 | 6 |
| d6-25(OH)-D3 Qual | | | | | | |
| Internal Std | 416.2 | 274.2 | 75 | 10 | 20 | 11 |
| d6-25-(OH)-D2 Quant | | | | | | |
| Internal Std | 416.2 | 136.1 | 75 | 10 | 38 | 15 |
| d6-25-(OH)-D2 Qual | | | | | | |

Those having ordinary skill in the art will appreciate that various changes can be made to the above embodiments without departing from the scope of the invention. Further, the features of one embodiment can be combined with those of other embodiments.

1. A method of detecting 25-hydroxyvitamin D₃ and 25-hydroxyvitamin D₂ in a biological sample, comprising:
processing the sample to prepare the sample for introduction into a tandem mass spectrometer;
ionizing said processed sample in an ion source of the tandem mass spectrometer so as to generate precursor protonated ions of said 25-hydroxyvitamin D₃, if present in said sample, at a mass-to-charge ratio of 401.3±0.3, and to generate precursor protonated ions of said 25-hydroxyvitamin D₂, if present in said sample, at a mass-to-charge ratio of 413.3±0.3;
selecting said precursor protonated ions of said 25-hydroxy vitamin D₃ and said 25-hydroxy vitamin D₂ in a first analyzer of said tandem mass spectrometer;
fragmenting at least a portion of said selected protonated ions of 25-hydroxy vitamin D₃ to generate at least one fragment ion having any of 257.2±0.3, 121.1±0.3; 133.1±0.3, and 147.1±0.3 mass-to-charge ratio, and fragmenting at least a portion of said selected protonated ions of 25-hydroxy vitamin D₂ to generate at least one fragment ion having any of 271.2±0.3, 133.1±0.3, 121.1±0.3, and 255.2±0.3 mass-to-charge ratio; and
using a second analyzer of said tandem mass spectrometer that is set to detect said at least one of said fragment ions of the 25-hydroxy vitamin D₃ and said at least one of said fragment ions of 25-hydroxy vitamin D₂ to identify any of said 25-hydroxy vitamin D₃ and 25-hydroxy vitamin D₂ in said sample.

2. The method of claim 1, wherein said step of processing the sample comprises using at least one LC column for selectively separating said 25-hydroxyvitamin D₃ and said 25-hydroxyvitamin D₂ from one or more other components of the sample.

3. The method of claim 2, wherein the step of using at least one LC column comprises using a trap column to bind said 25-hydroxyvitamin D₃ and said 25-hydroxyvitamin D₂ and subsequently using an analytical column to elute said bound 25-hydroxy vitamin D₃ and said 25-hydroxyvitamin D₂ for introduction into said tandem mass spectrometer.

4. The method of claim 3, wherein said step of using the LC column resolves at least one of said 25-hydroxyvitamin D₃ and 25-hydroxyvitamin D₂ from an isobaric interference.

5. The method of claim 1, wherein said ionization source comprises an electrospray ionization source.

6. The method of claim 1, further comprising quantifying concentration of said 25-hydroxy vitamin D₃ and said 25-hydroxyvitamin D₂ in said sample based on comparison of signal intensities corresponding to fragment ions associated with 25-hydroxyvitamin D₃ and signal intensities corresponding to fragment ions associated with 25-hydroxyvitamin D₂ with respective signal intensity obtained from at least one standard.

7. The method of claim 6, wherein said step of processing the sample comprises adding said at least one standard to said sample.

8. The method of claim 6, wherein said at least one standard comprises any of deuterated 25-hydroxyvitamin D₃ and deuterated 25-hydroxyvitamin D₂.

9. The method of claim 1, wherein said processing step comprises using any of a precipitating reagent and centrifugation.

10. The method of claim 1, wherein said 25-hydroxyvitamin D₂ and 25-hydroxyvitamin D₃ are detected in a single run of said tandem mass spectrometer.

11. A method for detecting at least two vitamin D metabolites in a biological sample, comprising:
processing the biological sample to prepare the sample for LC-MS/MS analysis;
passing said processed sample through a liquid chromatography column having an outlet connected to an inlet port of a tandem mass spectrometer to separate said two vitamin D metabolites and introduce said two vitamin D metabolites into the tandem mass spectrometer;
generating [M+H]⁺ ions of each of said two vitamin D metabolites in said tandem mass spectrometer;
generating for each of said fragment ions [M+H]⁺ ions associated with each of said two vitamin D metabolites at least one fragment ion, wherein said fragment ions are not due to water losses from said [M+H+] ions; and
detecting said fragment ions to identify presence of said two metabolites in said biological sample.

12. The method of claim 11, further comprising quantifying concentration of said two vitamin D metabolites in said sample by comparing intensities of detection signals associated with said fragment ions with a respective signal associated with at least one standard.

13. The method of claim 12, wherein said step of processing the sample comprises adding said at least one standard to the sample.

14. The method of claim 11, wherein said biological sample is a serum or plasma, a urine, a bile, a saliva, a tear sample.

15. The method of claim 11, wherein said step of using the LC column resolves at least one of said two vitamin D metabolites from an isobaric interference, optionally wherein said isobaric interference is 3-epi-25-hydroxyvitamin D₃.

16. The method of claim 11, wherein said liquid chromatography column is a pentafluorophenyl column.

17.-20. (canceled)

21. A kit for detecting and measuring the concentration of at least two vitamin D metabolites in a biological sample, comprising
two or more calibrators, each containing two or more standards with known concentrations in the calibrators selected from the group consisting of 25-hydroxyvitamin D₃, 25-hydroxyvitamin D₂, 1,25-dihydroxyvitamin D₃ and 1,25-dihydroxyvitamin D₂;
an isotopic version of at least one of the two or more standards, each of the isotopic versions having a known concentration;
a system suitability mixture comprising a known concentration of 25-OH-Vitamin D₃, a known concentration of 25-OH-Vitamin D₂ and a known concentration of 3-epi-25-OH-Vitamin D₃;
a pentafluorophenyl liquid chromatographic column;
one or more solvents; and
instructions for carrying out the method of claim 1.

22. A method of measuring the concentration of 25-hydroxyvitamin D₃ and 25-hydroxyvitamin D₂ in a biological sample, comprising:
processing the sample to prepare the sample for introduction into a tandem mass spectrometer, said processing the sample comprising injecting the sample into a single pentafluorophenyl column, and eluting a processed sample therefrom using a gradient to effect a separation;
ionizing said processed sample in an ion source of the tandem mass spectrometer so as to generate precursor protonated ions of said 25-hydroxyvitamin D₃, if present in said sample, at a mass-to-charge ratio of 401.3±0.3, and to generate precursor protonated ions of said 25-hydroxyvitamin D₂, if present in said sample, at a mass-to-charge ratio of 413.3±0.3;
selecting said precursor protonated ions of said 25-hydroxy vitamin D₃ and said 25-hydroxy vitamin D₂ in a first analyzer of said tandem mass spectrometer;
fragmenting at least a portion of said selected protonated ions of 25-hydroxy vitamin D₃ to generate at least one fragment ion having any of 257.2±0.3, 121.1±0.3; 133.1±0.3, and 147.1±0.3 mass-to-charge ratio, and fragmenting at least a portion of said selected protonated ions of 25-hydroxy vitamin D₂ to generate at least one fragment ion having any of 271.2±0.3, 133.1±0.3, 121.1±0.3, and 255.2±0.3 mass-to-charge ratio;
using a second analyzer of said tandem mass spectrometer that is set to detect said at least one of said fragment ions of the 25-hydroxy vitamin D₃ and said at least one of said fragment ions of 25-hydroxy vitamin D₂ to identify any of said 25-hydroxy vitamin D₃ and 25-hydroxy vitamin D₂ in said sample;
measuring a signal of the detected at least one of said fragment ions of the 25-hydroxy vitamin D₃ and said at least one of said fragment ions of 25-hydroxy vitamin D₂; and
using said signal to determine a quantity of any of said 25-hydroxy vitamin D₃ and 25-hydroxy vitamin D₂ in said sample.

23. The method of claim 22 wherein the ion source is an ACPI ion source.
